(19) United States
(12) Patent Application Publication
(10) Pub. No.: US 2005/0027707 A1
(43) Pub. Date: Feb. 3, 2005

(54) System and method of managing sensitive information exchanges between users of a matching service

(76) Inventor: Omar A. Syed, Lakewood, OH (US)

Correspondence Address: Erik J. Overberger, Esq.;Fay, Sharpe, Fagan, Minnich & McKee, LLP, Seventh Floor, 1100 Superior Avenue, Cleveland, OH, 44114-2518, US

(21) Appl. No.: 10/896,578

(22) Filed: Jul. 22, 2004

Related U.S. Application Data
(60) Provisional application No. 60/490,453, filed on Jul. 28, 2003.

(51) Int. Cl. G06F 7/00

(52) U.S. Cl. 707/9

(57) ABSTRACT

A method of managing sensitive information exchanges between users of a matching service includes receiving sensitive information from a first user and receiving a viewing option from said first user concerning the first user's sensitive information. A first user indication of interest is received from the first user, identifying a second user in whom the first user is interested. The second user is notified of the first user identification of interest, wherein a response is received from the second user concerning the first user identification of interest, the second user response one of interested or disinterested. The second user sensitive information is received from the second user if the second user response is interested, and the second user has not previously provided their sensitive information. The first user is notified of the second user response. Sensitive information is only displayed to both the first user and to the second user if the second user response is interested and the second user has provided their sensitive information.

This application claims priority to U.S. Provisional Patent Application No. 60/490,453, filed Jul. 28, 2003, and hereby incorporates that application by reference herein.

### BACKGROUND

The present invention relates to a system and method of managing sensitive information exchanges between users of a matching service such as, for example, dating, singles, friendship, match making and matrimonial web sites. Many users consider information such as photos of themselves, and personal information such a birth dates, annual income, etc. to be sensitive information that they would not want posted in their profile on a matching service for anyone to view. However, it is in the interest of a matching service to collect and display to other members as much pertinent information as permissible from each user so that other members can make a more informed decision about whether or not they would like to communicate with a particular user and, in the process, obtain a subscription to the service. The more members a service has, and the more pertinent information it provides, the greater the probability of converting free members to subscribers. Some of the pertinent information to be collected may be considered sensitive by the users and, thus, the users are hesitant to provide it. This requires the matching service to make such information optional, and many of the users will, therefore, not provide it. As a consequence, many users have to make decisions based on incomplete information on other members.

Although a user may consider some information to be sensitive and, therefore, is not willing to provide it openly for anyone to view, the user usually does not mind providing at least some of this information selectively to specific other members, or to a limited set of members of their choosing. This is especially true if the user knows that, in exchange for letting another member view his or her sensitive information, the user will be afforded the opportunity to view the other member's sensitive information. Typically, the users may exchange sensitive information through email or the like managed by the matching service after the initial communication is established through the matching service.

There are various methods by which matching services provide users with the ability to share their sensitive information with selected other members. One method allows each user to select which other members with whom to share the sensitive information, and allows the user to enable or disable access for just those members. One disadvantage of this method is that the users are burdened with the task of managing access to their sensitive information. A user who is no longer interested in someone may forget to disable the access for that member, or the user may be interested in someone, but forget to turn on the access for that someone. Another disadvantage of this method is that a user may allow access to his/her sensitive information, but the other member may not allow access to this user in return, especially after having already seen this user's sensitive information. Also, some users may not have provided their sensitive information to the service. Thus, the user is again faced with the problem of making a decision based on incomplete information about the other user.

The following U.S. patents, all expressly incorporated herein by reference, provide additional background information:

| | |
|---|---|
| 6,253,216 | Method and apparatus for providing a personal page |
| 5,950,200 | Method and apparatus for detection of reciprocal interests |
| | or feelings and subsequent notification |
| 6,480,885 | Dynamically matching users for group communications based |
| | on a threshold degree of matching of sender and recipient |
| | predetermined acceptance criteria |
| 6,282,515 | Integrated audiotext-internet personal ad services |
| 6,061,681 | On-line dating service for locating and matching people |
| | based on user-selected search criteria |
| 6,272,467 | System for data collection and matching compatible profiles |
| 5,963,951 | Computerized on-line dating service for searching and |
| | matching people |

### SUMMARY

In accordance with one aspect of the invention, a new and improved system and method is provided that enables a matching service to collect sensitive information from all users and allow said sensitive information to be displayed in a way that the users will be comfortable with. The method allows the users to specify just once to the service how they would like the sensitive information to be handled and not have to worry about enabling or disabling access on an individual level. Also, the system allows the matching service to guarantee the users that if their sensitive information is provided to another member that they will also be given access to the sensitive information of the other member. In addition, the method ensures all users that they will have complete information about any other member they choose before having to make a decision to proceed further.

In accordance with another aspect of the invention, a method of managing sensitive information exchanges between users of a matching service is provided. More particularly, in accordance with this aspect of the invention, sensitive information is received from a user of the matching service and the received sensitive information is stored on a database. Further, a viewing option is received from users defining sensitive information viewing rules for their respective, stored sensitive information. The viewing option is also stored on the database. An indication of interest is received from a first user interested in a second user and stored on the database. The second user is notified of the first user's interest and a response is received from the second user indicating one of mutual interest or non-interest. The response is also stored on the database. The sensitive information of the first user is provided to the second user when the received response indicates mutual interest and the sensitive information of the second user was received from the second user.

In accordance with yet another aspect of the invention, a method of managing sensitive information exchanges between users of a matching service is provided. More particularly, in accordance with this aspect of the invention, sensitive information is received from at least one user of the matching service. The received sensitive information is stored on a database. A viewing option is received from at least one user defining sensitive information viewing rules for the sensitive information received from each user. The received viewing option is stored on the database. An indication of interest is received from a user interested in a second user. The received indication of interest is stored on the database. The second user is notified of the first user's interest. A response is received from the second user indicating one of mutual interest or non-interest. The second user's response is stored on the database. The sensitive information of the first user is provided to the second user when the received response indicates mutual interest and the sensitive information of the second user was received from the second user.

In accordance with still yet another aspect of the present invention, a method of managing information exchanges between users of an online system is provided. More particularly, in accordance with this aspect of the invention, information is received from a first user. A viewing option is received from the first user. An indication of interest is received from the first user identifying a second user. The second user is notified of the indication of interest. A response is received from the second user concerning the first user. The information of the first user is provided to the second user when the response indicates interest of the second user in the first user and second user information was received from the second user.

### BRIEF DESCRIPTION OF THE DRAWINGS

The invention may take physical form in various components and arrangements of components and in various steps and arrangements of steps. The drawings are only for purposes of illustrating one or more embodiments and are not to be construed as limiting the invention.

FIG. 1 is a schematic overview of a system matching users of an online matching service and for managing sensitive information of the users of the matching service.

FIG. 2 is a block diagram illustrating a process for displaying the profile of a first user to a second user.

FIG. 3 is a block diagram illustrating a process to display the sensitive information of a first user to a second user.

FIG. 4 is a block diagram illustrating a process to display the options of a viewed user to a viewing user.

FIG. 5 is a block diagram illustrating processing of an indication of interest by a first user in a second user.

FIG. 6 is a block diagram illustrating processing of a yes/no button or active icon as provided to a user of the matching system.

FIG. 7 is a block diagram illustrating processing of a changed mind button or indication provided by the matching service to a viewing user.

FIG. 8 is a block diagram illustrating a process for a user to enter their sensitive information.

FIG. 9 is a block diagram illustrating a process to periodically clear pending interest requests.

FIG. 10 is a block diagram illustrating the interaction of a user with other members of the matching system.

### DETAILED DESCRIPTION OF THE PREFERRED EMBODIMENTS

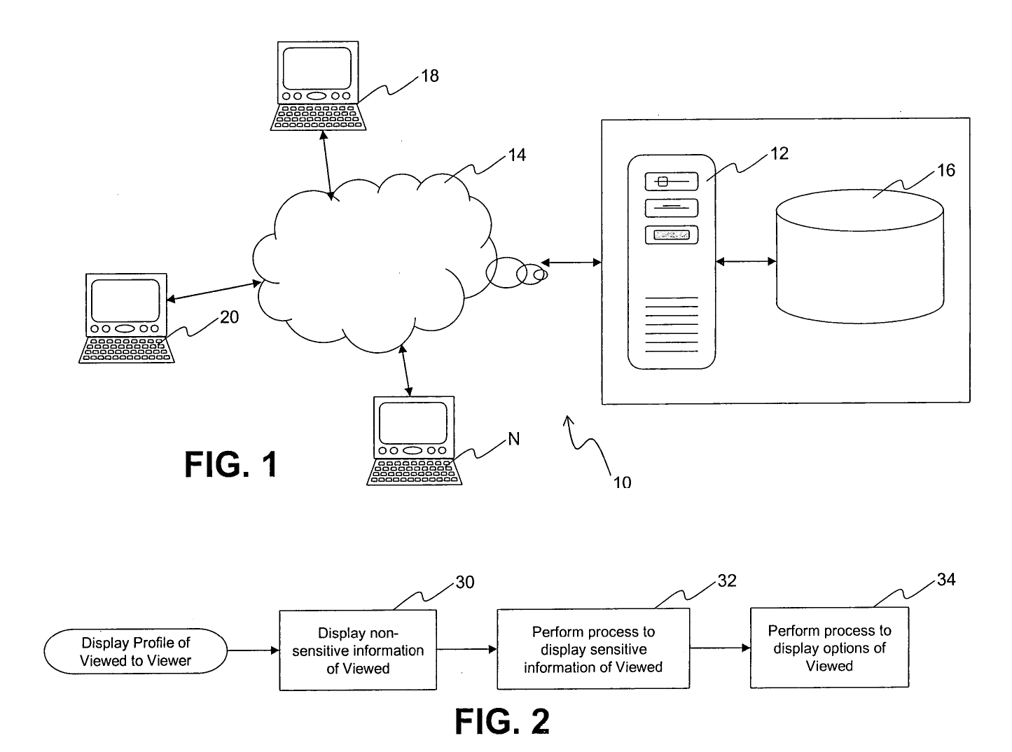

Referring now to the drawings wherein the showings are for purposes of illustrating one or more embodiments of the invention only, and not for purposes of limiting the same, FIG. 1 shows a system for matching users of an online matching service and managing sensitive information exchanges between users of the matching service, the system being generally designated by the numeral 10. The system includes a web or matching service host server 12 connected to a network 14 such as the Internet. The hosting server 12 includes, or is further connected to, a matching service database 16. The database 16 is configured to store information on a plurality of users of the system 10 as will be described in more detail hereinafter. Alternatively, the database 16 can be a plurality of databases linked to one another, as could the hosting server 12 be a plurality of servers configured to operate on a cooperative parallel basis. The invention is not limited with respect to physical hardware and system configurations.

The system 10 further includes at least a first communicating device 18 and a second communicating device 20, each capable of connecting to and communicating with the host server 12 over the network 14. A first user can communicate with the system 10 by using the first communicating device 18, and a second user can communicate with the system 10 by using the second communicating device 20. In this manner, both the first and second users can access the database 16 through the server 12 for purposes of recording information about themselves and/or retrieving information about one another, or other users, already stored in the database 16. Further, the first and second users can communicate with each other through the network 14 and the host server 12 as will be described in more detail below. The first and second communicating devices 18, 20 can be separated or geographically remote relative to one another which allows the first and second users access to the system 10 even if they are located remotely, relative to one another, and/or relative to the system 10.

Any number of users can communicate with the system 10 through the use of additional communicating devices. In FIG. 1, another communicating device is shown with the reference letter N attached thereto which is representative of any number of additional communicating devices operated by users to connect and communicate with the host server 12 and the database 16 via the network 14. Of course, it is also possible to have multiple users connecting and communicating with the host server 12 and accessing the database 16 through one or more shared communicating devices. In any form, the system 10 is adapted to be used by two or more users employing any number of communicating devices to communicate with the host server 12, the database 16 and each other via the network 14.

Further, the communicating devices are not restricted to any particular form of device or operating system. For example, some communicating devices may be a personal computer running any suitable operating system, while others may be terminal stations connected to the network 14 such as found, for example, at a library or an Internet kiosk. When a user, such as the first user, desires to access the server 12 and database 16, the user connects to the network 14 with a communicating device, such as the first communicating device 18. In the one embodiment, the network 14 is the Internet, and the communicating devices 18, 20 are personal computers with Internet access. Alternatively, the network 14 could be any type of network such as a proprietary network, a local intranet, a wireless network, a telephone network, etc., and the communicating devices could each be any device adapted to communicate with one of the aforementioned networks such as a local server, a telephone, a wireless phone, a personal digital assistant (PDA), a pager, a palm-top computer, a personal computer, etc.

Because the invention is directed towards a system and method of managing the exchange of sensitive information between users of the system, details of the system 10 not associated with the exchange of the sensitive information are not described in detail herein. For example, detailed procedures for typical tasks such as enrolling as a new member, subscribing to additional, fee-required premium services, etc., are not related to embodiments of the present invention and are only discussed when necessary to understand the present invention.

Further, it is to be understood that the words “user” or “users” as used herein are synonymous with the words “member” or “members”. These words are used to refer to a person who has provided a profile to the matching service, but may or may not have made a payment to receive additional benefits. The different words are used to distinguish one person from another, but do not otherwise have different meanings. The user or member, may be any of the aforementioned users, such as first user 18, second user 20, or any other of a plurality of users connected to the system 10 and database 16 via the network 14. The words “service” or “services” are likewise synonymous to the words “site” or “sites” and in both cases refer to the matching service operating on the system 10. In the description that follows, the words “user”, “users”, “member”, “members”, “service”, “services”, “site” and “sites” are used in the context just described.

A user who registers with the matching service running on the system 10 is asked to provide their profile information for storing on the database 16. The profile information is separated into non-sensitive and sensitive information (SI), and the user is aware of which information is considered sensitive information by the system, as for example, by the use of separate forms for non-sensitive and sensitive information, or by highlighting form fields considered sensitive information. The user is not required to enter data into the sensitive information portion of the profile when registering with the matching service and the user can provide the sensitive information at a later time or date.

In one embodiment, when entering (or uploading) sensitive information to the matching service, the user is given an opportunity to select from one of the following choices (e.g., round and/or square buttons) describing how the sensitive information should be managed by the service, wherein the terms “I” and “my” are references to the user entering the sensitive information:
Always allow SI to be viewed by members I have mutual interest with and
   do not allow anyone else (other users) to view the SI
   also allow the SI to be viewed by any user who matches my filter
   also allow the SI to be viewed by any user
   Allow my SI to be viewed only if the other member has also provided their SI

In some embodiments, the user may select one of the three options preceded by a round selection button and may also independently select the option preceded by the square selection button. Of course, the round and square buttons are representative only, and alternative embodiments may have more or less than three options, and the invention is not limited in this respect. Based on the above selections, it is possible for a user to specify one of the following six (6) rules, from the point of view of the entering user, on how the SI should be managed by the service:

1. Allow SI to be viewed by any other member

2. Allow SI to be viewed only by any other member who has also provided their SI

3. Allow SI to be viewed only by members I have mutual interest with

4. Allow SI to be viewed only by members I have mutual interest with and who have also provided their SI

5. Allow SI to be viewed only by members I have mutual interest with or who match my filter

6. Allow SI to be viewed only by members I have mutual interest with or who match my filter and have also provided their SI

A user viewing the profiles of other members sees either the SI of that member or a message such as one of the following exemplary messages in place of the SI:

1. SI available once you enter your SI

2. SI available after establishing mutual interest

If a user has never had any interaction with another member, and the user has an interest in the other member, the profile stored on the database 16 by the user will also contain an option to let the other member know that the user is interested in them.

A user who chooses to let another member know they are interested, but has not yet entered their own sensitive information, is first asked to enter their own sensitive information. Once the sensitive information has been provided, the user may instruct the system to send a notice to let the other member know of their interest. Optionally, there can be a time limit (such as seven days) within which the other member is expected to reply with an indication of mutual interest, or lack thereof. Further, in some embodiments, an automatic reply can be generated if no response is received within the time limit for the reply.

When the other member views the profile of the interested user, the other member is shown either the sensitive information of the user or a message based on the viewing option chosen by the first user as stored on the database 16. The other member is given an opportunity to select an option to indicate if they are also interested, or not interested, in the interested user. If the other member chooses the not-interested option, the interested user is notified about the choice. The other member will still retain the option to change their mind, and may indicate at a later that they are now interested in the interested user.

If the other member chooses that they are also interested but has not yet provided their sensitive information, the other member is asked to enter their sensitive information. Once the sensitive information has been provided, the system sends a notice to let the first user know that interest has been established between both users.

Once both users have established mutual interest, they will be able to view each others sensitive information regardless of other chosen options. If one of the users is no longer interested in the other, and has indicated this non-interest to the system, then the users will no longer be able to view each other's sensitive information unless one of the other chosen options allows it, or it has been less than a fixed amount of time (for example, 7 days) since the mutual interest was established.

One assumption made by this method is that any user who wants to see the sensitive information of another member that they are interested in should be willing to exchange their own sensitive information with that other member. Thus, the service can treat sensitive information as required information that will eventually be collected from the user if the user wants to establish mutual interest with another member. So a user who has not yet provided their sensitive information is treated as if it is provided but has chosen to show it only after mutual interest with another member has been established. Thus, there is preferably no user for which the service is required to indicate that the sensitive information is not available, and the service can always indicate, at least, that the sensitive information is available after mutual interest is established. It is advantageous to the goal of attracting additional members if the service can indicate that the sensitive information of all, or a substantial portion of all, other members is available. Once this assumption is made, features are easily provided which benefit the users and the service.

Advantageous features provided by the described embodiments include:
1. The ability for the service to indicate that the sensitive information of all users is available, thereby attracting more users to the service.
2. The service can allow the sensitive information to be entered when the user wants, and not require the sensitive information when the profile is provided.
3. The service is assured that most, or all, users will eventually provide their sensitive information if they continue to use the service.
4. There is no need for users to worry about others being able to view their sensitive information, and the users have more control over who can view it.
5. Users are assured that the service will provide the sensitive information of other members before making a decision to proceed further.
6. Users are assured that, if another member views their sensitive information, they will also have a chance to view the sensitive information of the other member.
7. Users do not need to worry about enabling or disabling access to the sensitive information on an individual basis; it is managed by the service based on the user's current interest in other members.

A matching service may optionally separate the sensitive information into sets of sensitive information and allow different viewing options to be specified for each set. Although this requires the display of each set of sensitive information to be processed separately, it does not change the process of displaying any set of sensitive information and thus falls within the scope of the present invention.

It is also possible in alternative embodiments for a service to not provide some of the options on how the sensitive information should be displayed. However, any service providing even a subset of these options is intended to fall within the scope of the present invention.

It is additionally possible for a service to not require a fixed time within which to reply to an interest request from a user. This is not a requirement of the present invention. Thus, a service which does not provide this feature is still considered to be encompassed by methods of the present invention.

With reference now to FIG. 2, a method of displaying the profile of a first user (viewed) to a second user (viewer) is shown. In the embodiment shown, the non-sensitive information of the first user's profile is displayed or prepared for display at step 30. This information, being considered non-sensitive, is not subject to further sensitive information type processing before display. Subsequently, at step 32, a process is performed to display, or prepare for display, sensitive information of the first user, which may be viewed by the second user according to the aforementioned options selected by the first user. A process is performed at step 34 to display any options which are relevant to the second user with respect to the first user.

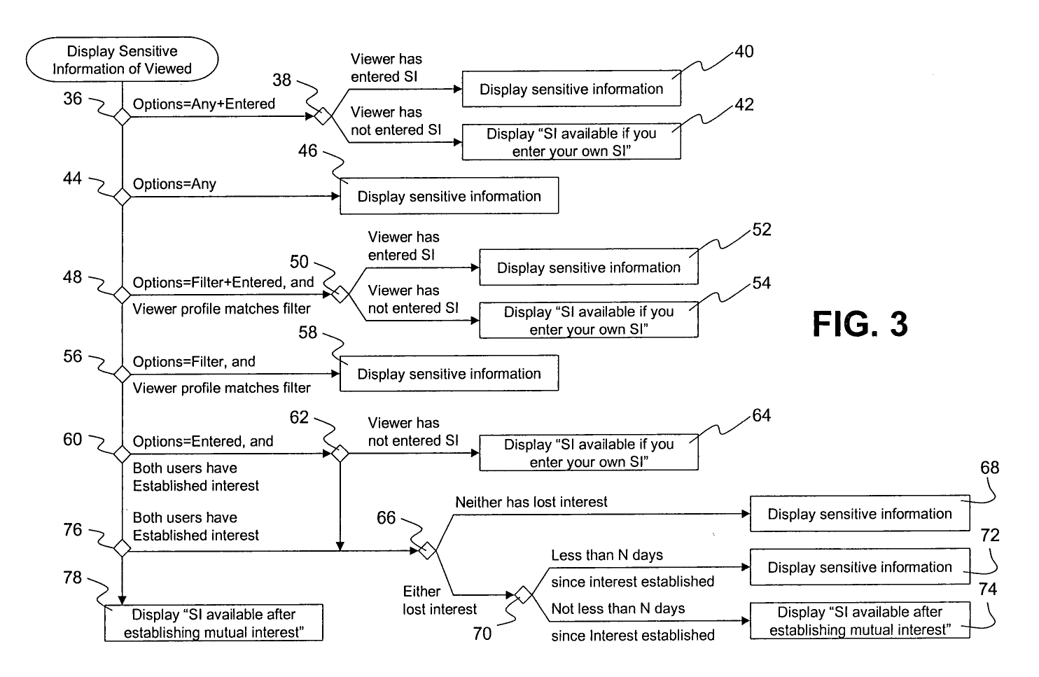

With attention now to FIG. 3, the process of step 32 to display the sensitive information of a first user to a second user is described in further detail. At step 36, it is determined if the first user has chosen the combination of options to allow any user to view their sensitive information, provided that the viewing user has also entered their own sensitive information. In this case, it is determined at step 38 whether or not the second user has entered their sensitive information and, if so, the sensitive information of the viewed first user is prepared for display at step 40. Otherwise, at step 42, the viewing second user is presented with a message indicating that the sensitive information of the first user will be available once they, the second user, enters their own sensitive information. At step 44, it is determined if the first user has allowed that any other user may view their sensitive information without requiring the viewing user to enter their own sensitive information, thus allowing the sensitive information of the first user to be presented for display at step 46.

If the first user has not chosen the option permitting any user to view their sensitive information, it is now determined at step 48 if the first user has chosen a combination of options which allow a user matching a filter provided by the first user to view their sensitive information, provided that the viewing user has provided their own sensitive information, and further, if the viewing user matches the profile provided by the first user. If this is determined to be the case, it is determined at step 50 whether or not the second user has entered their own sensitive information and, if so, the sensitive information of the first user is presented for display at step 52. However, if the second user has not yet entered their own sensitive information, a message is presented for the second user at step 54, indicating that the sensitive information will be made available once the second user has entered their own sensitive information. At step 56, it is determined if the first user has provided the aforementioned filter, but does not require that the viewing user enter their own sensitive information. In this case, at step 58, the sensitive information is presented for display to the second user.

If none of the above-described conditions have been determined to be true, it is determined at step 60 if the first user has chosen a combination of options which allow a user having established a mutual interest to view their sensitive information, provided that the viewing user has provided their own sensitive information. In this case, it is determined at step 62 whether or not the second user having a mutual interest has entered their own sensitive information and, if not a message is presented for the second user at step 64, indicating that the sensitive information will be made available once the second user has entered their own sensitive information. It is to be appreciated that these just-described steps 60-64 are redundant in view of the following description of processing at step 76, but are provided for completeness and are not necessary in the preferred embodiment because, in order to have established a mutual interest, both users will have already entered their respective sensitive information and it is, therefore, not necessary to verify that the other user has entered their sensitive information.

If the second user has provided their sensitive information, processing proceeds to step 66 where it is further determined whether either of the users has lost interest in the other, and if neither has lost interest in the other, the sensitive information is presented for display to the second user at step 68. If, however, either or both of the users has lost interest in the other, it is determined at step 70 if it has been less than a predetermined period of time, preferably a number of days, such as 7 for example, since the original interest was established and, if this is the case, the sensitive information is prepared for display to the second user at step 72. On the other hand, if it has not been less than the predetermined number of days since interest was established, a message is provided to the second user at step 74, indicating that the sensitive information of the first user will be available after establishing a mutual interest.

If it is determined at step 76 that the first user and the second user have established a mutual interest, and the first user does not require that the viewing user provide their own sensitive information, processing continues at the above-described step 66.

The default action of the process to display sensitive information of a viewed user, when none of the previously described options provided by the viewed user have been satisfied, is to display a message to the viewing user at step 72 indicating that the sensitive information of the viewed user will be made available after establishing mutual interest between the two users.

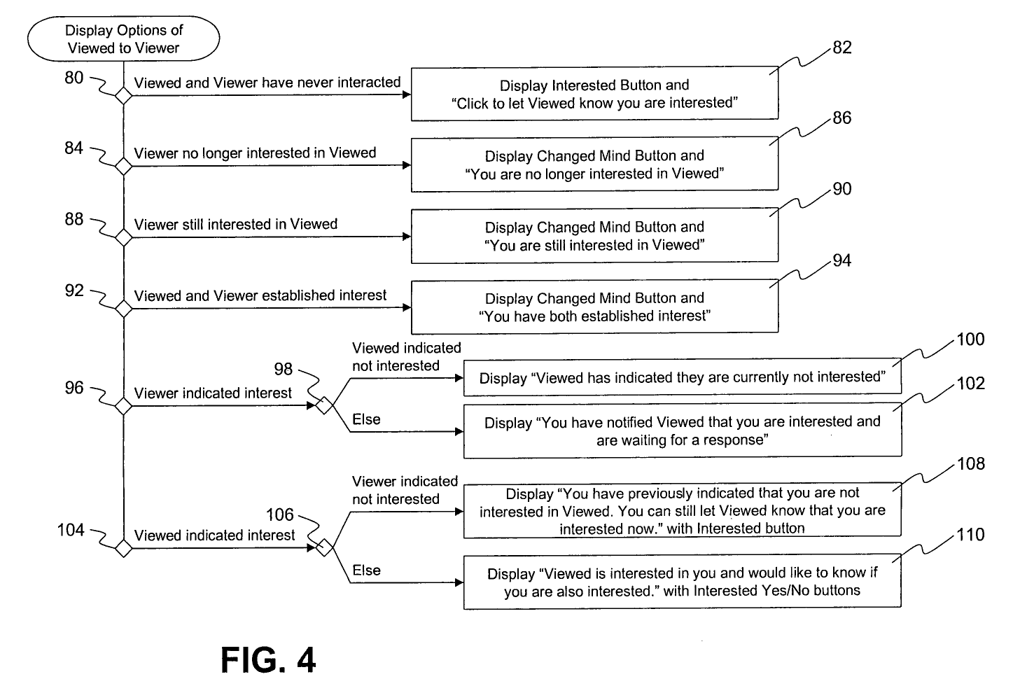

With attention directed now to FIG. 4, the process to display the options of a viewed user to a viewing user is described. At step 80, it is determined if the viewed first user and the viewing second user have ever interacted and, if not, a message is displayed at step 82 to the second user offering an option to let the first user know that they, the second user, are interested. If, however, it is determined at step 84 that the second user had previously indicated that they were no longer interested in the first user, a message is presented to the second user that they had indicated they were no longer interested in the first user, and a changed mind button is provided, at step 86, in case the second user wishes to indicate a renewed interest. It is now determined at step 88 if the second user still maintains an interest in the first user, wherein the first user has not yet indicated a mutual interest. In this case, at step 90, a message is displayed to the second user that they are still interested in the second user, along with a changed mind button in case the second user wishes to withdraw the interest that they had previously shown.

If both the viewed first user and the viewing second user have previously established a mutual interest as determined at step 92, a message is displayed at step 94 to the second user indicating that both users have previously established a mutual interest, and a changed mind button is included to allow the second user to indicate a change of mind with respect to interest in the first user. At step 96, it is determined if the second user has indicated an interest in the first user and, if so, at step 98, it is determined if the first user has indicated a not interested condition with respect to the second user and, if so, at step 100, a message is presented to the second user that the first user has indicated they are not currently interested in the second user. Otherwise, at step 102, a message is presented indicating to the second user that they have already notified the first user of their interest in the first user, and are waiting for a response from the first user.

Finally, at step 104, it is determined if the first user has indicated an interest in the second user and, if so, at step 106, it is determined if the second user has previously indicated that they are not interested in the first user and, if so, at step 108, a message is displayed to the second user indicating such, and they are additionally informed that they can still let the first user know of a change in mind regarding their interest if they so wish. An option to indicate interest is also provided to the second user. Otherwise, a message is presented to the second user at step 110 indicating that the first user is interested and would like to know if the second user is also interested, along with appropriate yes/no buttons for the second user to optionally make use of.

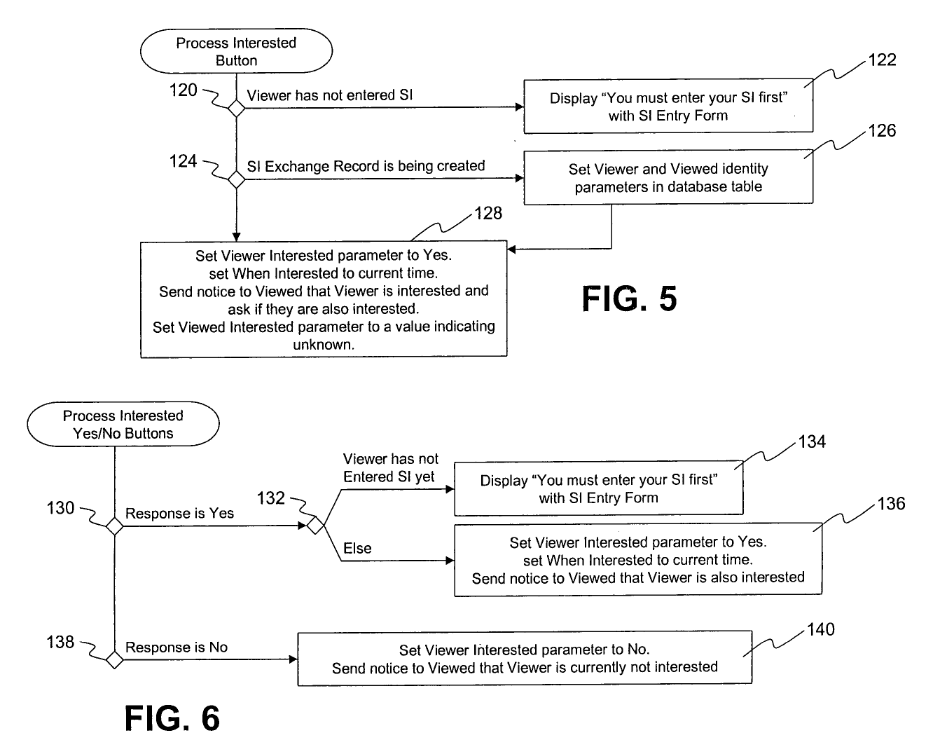

In screens displayed by the service to a viewing user, many times a button or an active icon are provided to the viewing user to utilize, indicating an interest, or lack thereof, in a viewed user. In FIG. 5, a method for processing an indication of interest is described. At step 120, after a viewing user has indicated an interest in a viewed user, it is determined whether or not the viewer has yet entered their sensitive information and, if not, at step 122, the viewing user is provided with a message indicating that they must first enter their sensitive information, and they are preferably provided with a sensitive information entry form with which to perform this task. If, however, the viewing user has entered the sensitive information, at step 124 it is determined if a sensitive information exchange record is currently being created in the database 16 and, if so, viewer and viewed identity parameters are set in the exchange record pointing to the viewed user and viewing user. In any case, however, where the viewer has entered their sensitive information, at step 128, various parameters in the database 16 with respect to the viewer and the viewed are initialized. For example, a viewer interested parameter is set to a yes value, a viewed interested parameter is set to a value indicating unknown, a when-interested parameter is set to the current time value, and additionally, a notice is sent to the viewed user that the viewing user is interested, and the viewed user is asked if they are also interested.

A method is now described with respect to FIG. 6 for processing a yes/no button or active icon as provided to a user of the matching system. If it is determined at step 130 that a yes response is indicated by the user, at step 132 it is determined if the viewing user has not yet entered their sensitive information and if this is the case, a message is displayed at step 134 indicating that they must first enter their sensitive information. The viewing user is preferably provided with a sensitive information entry form for their convenience. Otherwise, at step 136, the viewer interested parameter is set to the yes value in the database 16, and the when interested parameter is set to the current time value. A notice is preferably sent to the viewed user indicating that the viewing user is also interested. If, as determined at step 138, the users response is a no selection, at step 140 the viewer interested parameter is set to a no value, and a notice is preferably sent to the viewed user that the viewing user is currently not interested.

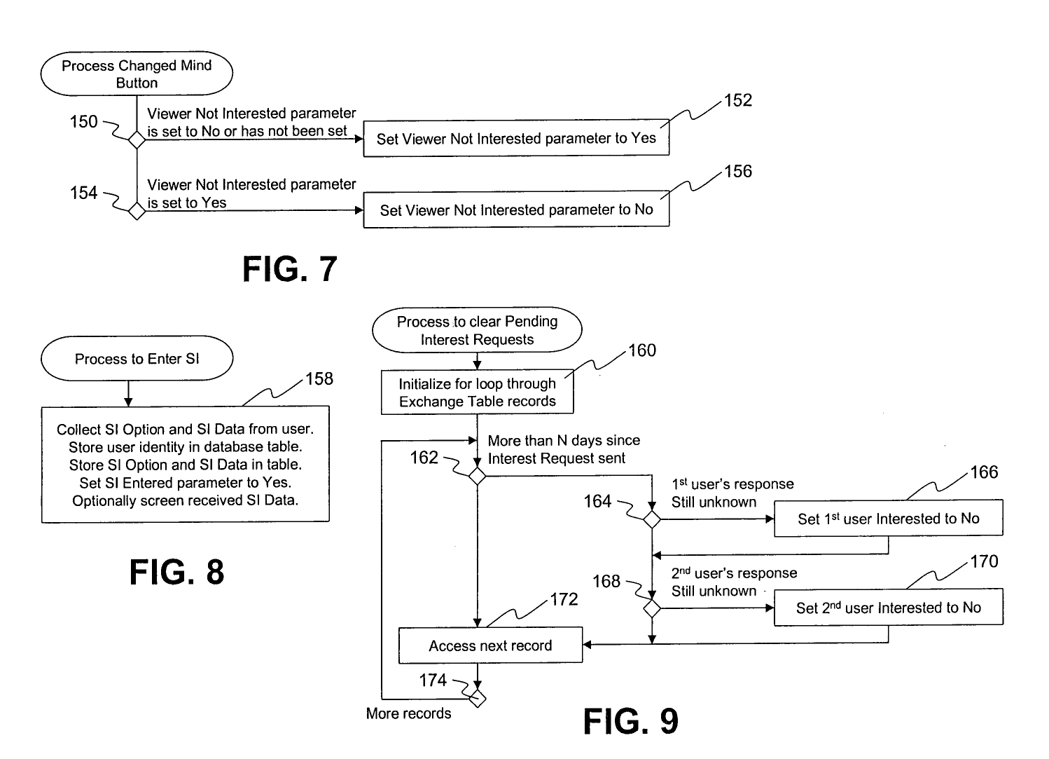

Turning now to FIG. 7, a method of processing a changed mind button or indication provided by the matching service to a viewing user is described. At step 150, it is determined whether the viewing user has previously indicated that they are no longer interested in the viewed user. If it is determined that the viewing user has not previously indicated a lack of interest in the viewed user, at step 152 a viewer not interested parameter is set in the database 16 to a yes condition with respect to the viewed user. If, however, the viewing user had previously indicated that they are no longer interested in the viewed user, at step 156 the viewer not interested parameter is, instead, set to a no condition in the database 16.

In FIG. 8, a summary of a method for a user to enter their sensitive information is provided. In step 158, the sensitive information options and the sensitive information data is collected from the user preferably by means of forms provided to the user on a display screen. The user identity, the sensitive information options, and the sensitive information data provided by the user are stored in the database 16 table for the providing user, and a sensitive information entered parameter is preferably set to a yes condition in the database 16, for reference at later times. However, in alternative embodiments, prior to setting the sensitive information entered parameter to a yes condition, a screening process may be performed on the sensitive information to ensure the validity and truthfulness of the sensitive information. The screening process may be an automated, computerized process in some embodiments while, in other embodiments, the screening may be performed by personnel employed for that purpose. In these embodiments, the sensitive information entered parameter will only be set to a yes condition after a successful screening process.

The matching service periodically runs a process to clear pending interest requests provided by users of the system. This process is preferably run on a regular basis, for example, approximately once each day. The process to clear pending interest requests is illustrated in FIG. 9, and, at step 160, initialization takes place for a loop through records in an exchange table on the database 16. At step 162, for the current record being examined in the exchange table, it is determined if it is more than a predetermined number of days since an interest request has been sent by a user to another user. If this is the case, at step 164 it is determined if a first user response, representing one of the users, is still unknown, and, if so, at step 166, the first user's interested parameter is set to the no value, assuming from a lack of a response that they have no interest in the other user. Likewise, at step 168, it is determined if the second user's response to an interest request is still unknown. If this is determined to be the case, the second user's interested parameter is set to the no value at step 170, again assuming a lack of interest due to a lack of response. In all cases, processing continues to step 172 where the next record in the exchange table on database 16 is accessed, and if it is determined that another record exists at step 174, processing iteratively returns to step 160 in order to process each record in the exchange table.

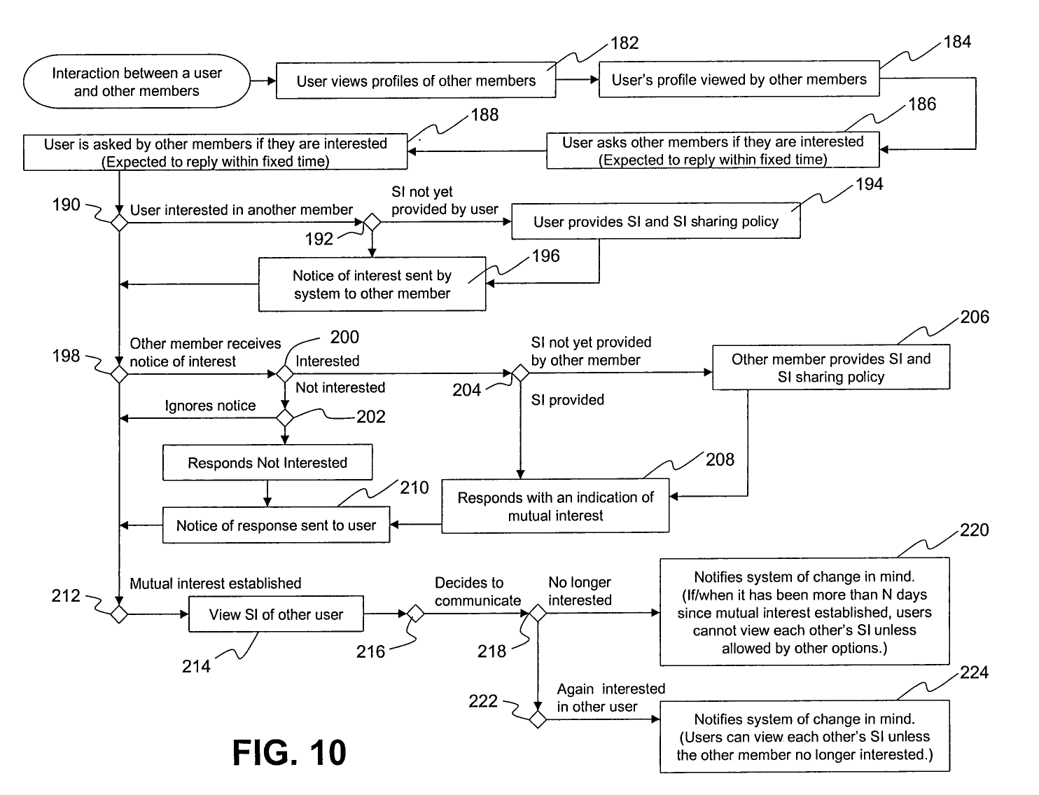

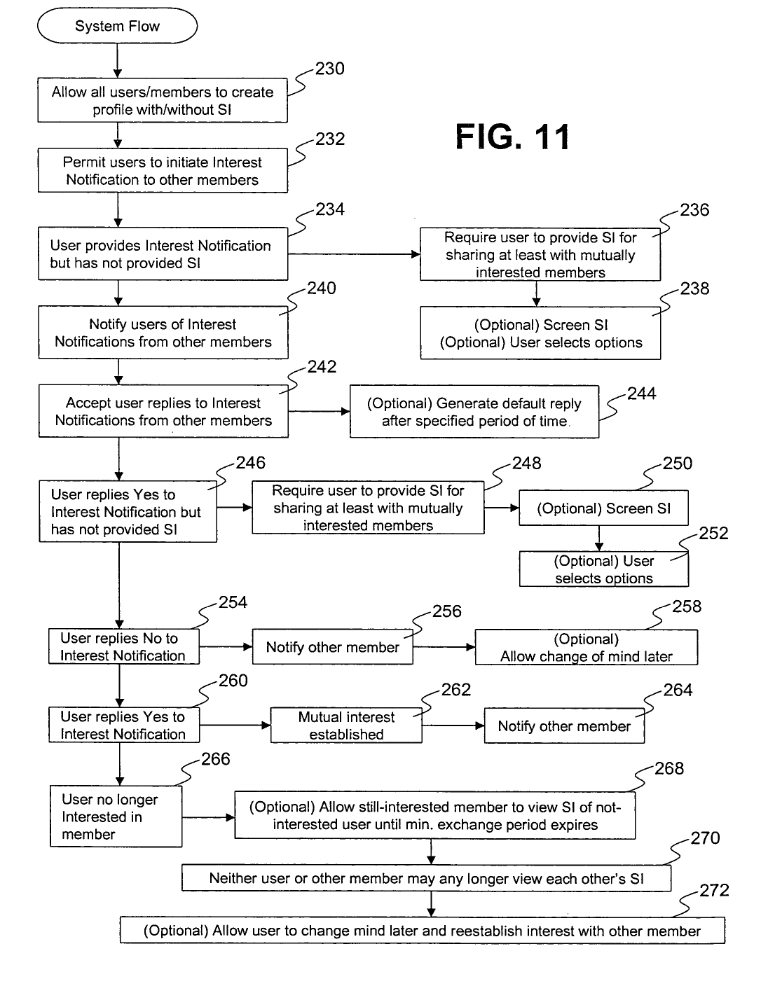

As an aid to understanding embodiments of the present invention, FIG. 10 provides a flow chart illustrating the interaction of a user with other members of the matching system. It is to be understood that the flow chart shown in the figure is representative of the system interaction from the point of view of the users of the system, and not a system flow chart in itself. Further, the flow chart includes options that are not required for practicing concepts of the present application, but are included as an aid to understanding alternate embodiments of the system. Generally, at step 180, new users of the system provide a profile for other members to view when browsing or searching the database 16. Thereafter, the user, at step 182, views the profiles of other members of the matching service. At step 184, on the other hand, the user's profile is also viewed by other members of the system. At step 186, the viewing user may ask another member of the matching service if they are interested in the viewing user, and, preferably, that a reply is expected from the viewed user in a predetermined period of time. Similarly, at step 188, the viewing user may be asked by another member if the viewing user has a mutual interest in the other member and, likewise, a reply is expected within the predetermined period of time.

A more detailed diagram of the interactive processing that occurs when a viewing user develops an interest in another member is presented at step 190, It is first determined at step 192 if the viewing user has not yet provided their sensitive information and, if not, at step 194, the viewing user must, if wishing to proceed further, provide their sensitive information to the matching service for storing in database 16. The viewing user also provides a sensitive information sharing policy which defines what level of access other members have with respect to viewing the provided sensitive information as previously described. The viewing user should, at this time, have a clear understanding of who will be able to view their sensitive information. The system requires that they at least share their sensitive information with other members they have a mutual interest in. At step 196, a notice of interest is sent by the system to the user whom the viewing user has developed an interest in.

At step 198, the flow diagram illustrates the interactive processing when the other member receives the notice of interest sent by the viewing user. At step 200, the other member makes a decision regarding mutual interest in the notifying user. The member receiving the notice of interest may, at step 202, respond with a not interested reply for the viewing user, or may just decide to ignore the notification of interest. If, however, the other member decides to respond in the affirmative with regard to mutual interest, at step 204, it is determined if the other member has not yet provided their sensitive information and, if not, at step 206, the other member must also, if still wishing to respond in the affirmative, provide their sensitive information to the matching service for storing in database 16. The other member, like the viewing user, also provides a sensitive information sharing policy. At step 208, the other member provides a yes response to the system regarding mutual interest in the viewing user. At step 210, either a notice of mutual interest or a notice of non-interest, according to the other member's response, is sent to the viewing user who had previously notified the other member of a desire to establish mutual interest.

If it is determined at step 212 that a mutual interest has been established with another user, at step 214 the viewing user may choose to view the sensitive information of the mutually interested user. At step 216, the viewing user may decide to communicate with the interested user, however, at step 218, it may be determined that the viewing user is no longer interested in the other user and, at step 220, the viewing user notifies the system of a change in mind. It is to be noted here that the previously mutually interested users will preferably continue to be able to view each others sensitive information for a predetermined number of days. However, after the predetermined number of days has expired, the users will no longer be able to view each others sensitive information unless permitted by other previously described options. It may be determined at step 222 that the viewing user is again interested in another user with whom the viewing user had previously indicated they were no longer interested. In this case, at step 224, the viewing user notifies the system of a change in mind. It is to be noted here that the two users can now view each others sensitive information unless the other member with whom the viewing user is interested has now indicated that they are no longer interested in the viewing user. In this case, the users will not be able to view each others sensitive information unless allowed by other options as previously described.

With reference now to FIG. 11, a flow chart is provided which illustrates functional aspects of the matching system. Optional aspects of the matching system are included in the flow chart, however, the optional aspects are not necessary in all embodiments and are, therefore, labeled as optional in the flow chart. Further, the functional aspects of the matching system are shown in an order intended to further a complete understanding of the system and the system is not limited to processing the functional aspects in any particular order. Typically, the functions shown are invoked or driven by user input or, in other words, are event driven.

Generally, at step 230, the system provides facilities for all users of the system to create a profile for other members to view. The created profile may be created with or without the user's sensitive information. At step 232, the system provides facilities allowing users to initiate an Interest Notification, indicating an interest in another member. If the system determines at step 234 that a user has attempted to initiate an Interest Notification, but has not yet provided their own sensitive information in their profile, at step 236, the user is required to provide the missing sensitive information for sharing, at least, with mutually interested members. Until the sensitive information is provided, the system does not notify the other member of the user's interest. Optional steps 238 include screening the sensitive information with either an automated process or a manual process performed by system personnel, and permitting the user to provide sharing options, or rules for sharing their sensitive information with other members.

At step 240, functionality is provided for notifying users of Interest Notifications directed to them from other Members who have provided their own sensitive information. The notifying members are provided with facilities for accepting replies to the Interest Notifications from the notified user at step 242. Optionally, at step 244, a default reply may be generated after a predetermined period of time.

If the system determines at step 246 that a user has attempted to reply in the affirmative, or yes, to an Interest Notification, but has riot yet provided their own sensitive information in their profile, at step 236, the user is required to provide the missing sensitive information for sharing, at least, with mutually interested members as hereinbefore described. Until the sensitive information is provided, the system does not provide the affirmative response to the initiating member. Optional step 238 provides screening of the sensitive information, and optional step 252 enables the user to input sharing options for the sensitive information. On the other hand, if the user replies in the negative, or no, to an Interest Notification at step 254, the system notifies the other member at 256 of the negative response, and no sensitive information will be shared unless permitted by other options. Optionally, a function may be provided at step 258 for allowing the user to change their mind at a later time.

When the requisite sensitive information has been provided by both the Interest Notification generating member and the responding user, the system accepts an affirmative response from the user at step 260, and establishes a mutually interested status at step 262. The system then notifies the other member, at step 264, of the affirmative response to the Interest Notification.

It may happen that a user is no longer interested in another member with whom a mutual interest has been established, and the system accepts a no longer interested notification at step 266 in such a situation. Some embodiments may provide an option at step 268 wherein the still-interested member is allowed to view the sensitive information of the non-interested user until a minimum exchange period has expired. Except as permitted by other options, or the optional minimum exchange period, the system, at step 270, takes action to no longer permit either the user or other member to view each other's sensitive information. An optional step 272 may be provided in some embodiments to allow the user to have a change of mind at a later time, and to reestablish interest with the other member.

To facilitate the processing as described above, in conjunction with FIGS. 2-10, the database table 16 stores data fields which enable the controlled exchange of information between users of the matching service. For example, the database table, in order to store the sensitive information for a user and keep the state of how the user wishes the matching service to handle their sensitive information, includes fields for storing the user identity, indicating if the sensitive information has been provided to the service, indicating options chosen for handling the sensitive information, and fields for storing the sensitive information provided by the user.

In order to maintain the state of a sensitive information exchange between two users, the database table further includes fields for identifying the first user and second users, indicating if the first user is interested in the second user, indicating if the second user is interested in the first user, the time when the interest was initiated or established, indicating if the first user is no longer interested, and indicating if second user is no longer interested. Fields which indicate a user's choice (such as being interested in a user) preferably have a value of yes, no or unknown, and are all initially set to unknown.

Preferably, the database 16 also stores system parameters useful for coordinating overall operation of the matching service system. For example, time limits are defined by stored parameters which provide the predetermined time limit within which the second user must indicate whether or not they are interested in the first user (7 days for example), and the predetermined time limit of how long, after establishing mutual interest, interested users can view each other's sensitive information.

Useful system constants may also be defined and stored in the database 16. For example, constant values may be stored on the database and used to indicate the following options chosen by a user: allow any other user to view their sensitive information, allow any user who matches their provided filter to view their sensitive information, allow only the users with whom mutual interest is established to view their sensitive information, and allow any user who has provided sensitive information to view their sensitive information.

The above-described data fields and constants stored on the database 16, are exemplary only, and are provided for furthering an understanding of the database 16 and how it is used in conjunction with the present invention.

The exemplary embodiment has been described with reference to the embodiments. Obviously, modifications and alterations will occur to others upon reading and understanding the preceding detailed description. It is intended that the exemplary embodiment be construed as including all such modifications and alterations insofar as they come within the scope of the appended claims or the equivalents thereof.

1. A method of managing sensitive information exchanges between users of a matching service, the method comprising:
a) receiving first user sensitive information from a first user;
b) receiving a first user viewing option from said first user concerning said first user sensitive information;
c) receiving a first user indication of interest from said first user, said first user indication of interest identifying a second user;
d) notifying said second user of said first user identification of interest;
e) receiving a second user response from said second user concerning said first user identification of interest, said second user response one of interested or disinterested;
f) receiving second user sensitive information from said second user if said second user response is interested and said second user has not previously provided said second user sensitive information;
g) notifying said first user of said second user response; and
h) only displaying both said first user sensitive information to said second user and said second user sensitive information to said first user if said second user response is interested and said second user has provided said second user sensitive information.

2. The method of claim 1 further including:
displaying said first user sensitive information to said second user if said first user viewing option is set to display to anyone.

3. The method of claim 1 further including:
displaying said second user sensitive information to said first user if a second user viewing option is set to display to anyone.

4-19. (Canceled)

20. A method of managing sensitive information exchanges between users of a matching service, the method comprising:
a) receiving a user profile from each of the users, each user optionally providing respective sensitive information in the profile;
b) receiving an Interest Notification from a first one of the users, the Interest Notification indicating an interest in a second one of the users;
c) processing the received Interest Notification, including the steps of:
1) requiring the first one of the users to provide their sensitive information if the sensitive information of the first user has not been previously provided; and
2) notifying the second user of the received Interest Notification;
d) receiving a reply from the second user with respect to the Interest Notification;
e) processing the received reply, including the steps of:
1) if the received reply is a No indication, notify the first user of the No indication; and
2) if the received reply is a Yes indication, performing the steps of:
i) requiring the second one of the users to provide their sensitive information if the sensitive information of the second user has not been previously provided;
ii) establishing a mutual interest between the first user and the second user; and
iii) notifying the first user of the Yes indication;
f) allowing the first user and the second user to share sensitive information if the first and second users have previously established a mutual interest;
g) receiving a No Longer Interested indication from a first interested user with respect to a second interested user, the mutual interest having been previously established between the first and second interested users, including the step of:
1) disabling the established mutual interest between the first and second interested users, thereby disabling sharing of sensitive information between the first and second interested users.

21. The method of claim 20, further including:
h) screening the provided sensitive information; and
i) determining the validity of the provided sensitive information prior to considering the sensitive information as having been provided.

22. The method of claim 20, further including:
h) defaulting to an automatic reply if the reply is not received within a predetermined period of time.

23. The method of claim 20, further including:
h) receiving a change of mind request from the second user after having received the reply with the No indication, thereby changing the No indication to a Yes indication.

24. The method of claim 20, further including:
h) allowing viewing by the second interested user of the first interested user's sensitive information for a minimum exchange period of time after receiving the No Longer Interested indication from the first interested user.

25. The method of claim 24, further including:
i) requiring a minimum interested period of time following establishing the mutual interest before honoring a received No longer Interested indication.

26. The method of claim 20, further including:
h) allowing the first interested user to submit a change of mind following the receiving of the No Longer Interested indication, the submitted change of mind indicating a reestablished mutual interest.

27. The method of claim 20, further including:
h) receiving a viewing option from at least one user defining sensitive information viewing rules for the sensitive information received from the at least one user.

28. The method of claim 27, further including:
i) providing the sensitive information of a viewed user to a viewing user when the received viewing option of the viewed user allows the viewing user to view the sensitive information whether or not the viewing user has provided their sensitive information.

29. The method of claim 27, further including:
i) receiving a filter from at least one user;
j) providing the sensitive information of a viewed user to a viewing user if the viewed user matches the received filter of the viewing user, and the received viewing option of the viewed user allows the viewing user matching the received filter to view the sensitive information of the viewed user, and the sensitive information of the other user was received from the other user.

30. The method of claim 27, further including:
i) receiving a filter from at least one user;
j) providing the sensitive information of a viewed user to a viewing user if the viewed user matches the received filter of the viewing user, and the received viewing option of the viewed user allows the viewing user matching the received filter to view the sensitive information of the viewed user without providing sensitive information.

31. The method of claim 27, further including:
i) providing the sensitive information of a viewed user to a viewing user if the received viewing option of the viewed user allows any user providing their sensitive information to view the sensitive information of the viewed user, and the sensitive information of the viewing user was received from the viewing user.

32. The method of claim 27, further including:
i) providing the sensitive information of a viewed user to a viewing user if the received viewing option of the viewed user allows any user to view the sensitive information of the viewed user.

33. The method of claim 27, further including:
i) displaying an instructive message to a viewing user when the sensitive information of a viewed user is not provided to the viewing user.

34. The method of claim 20, further including:
h) selectively storing the received user profile, the received Interest Notification, the received reply, the established mutual interest, and the received No Longer Interested indication on a database.

35. A method of managing information exchanges between users of an on-line system, the method comprising:
a) receiving information from a first user;
b) receiving a viewing option from the first user;
c) receiving an indication of interest from the first user identifying a second user;
d) notifying the second user of the indication of interest;
e) receiving a response from the second user concerning the first user; and
f) providing the information of the first user to the second user when the response indicates interest of the second user in the first user and second user information was received from the second user.

36. The method of claim 35, further including:
storing the information from the first user in a database;
storing the viewing option from the first user in the database;
storing the indication of interest in the database; and
storing the response from the second user in the database.
